(19) United States
(12) Patent Application Publication
(10) Pub. No.: US 2003/0157270 A1
(43) Pub. Date: Aug. 21, 2003

(54) Process for plasma sulfurization in vacuum

(76) Inventors: Xu Wang, City Of Industry, CA (US); Can-Lian Huang, City Of Industry, CA (US)

Correspondence Address: XU WANG, 17890 CASTLETON STREET, #369, CITY OF INDUSTRY, CA, 91748, US

(21) Appl. No.: 10/081,016

(22) Filed: Feb. 19, 2002

(51) Int. Cl. B05D 3/00; H05H 1/24

(52) U.S. Cl. 427/569; 427/294

(57) ABSTRACT

The invention relates to a process for sulfurization of workpiece in vacuum, including cleaning the surface of workpieces, loading the workpieces into vacuum chamber, vacuum pumping, heating the sulfur source for sublimating thereof, making the gaseous sulfur ionized in the presence of a high electrical field and sulfurizing the workpieces, removing the workpieces from the vacuum chamber, wherein after the workpieces being cleaned, putting them into the vacuum chamber that has a pressure-rising rate up to 10⁻³ Pa/h and a ultimate vacuum up to 0.1 Pa, vacuuming to 20 to 100 Pa; heating the workpieces placed on the cathode plate at 35 to 120° C. for 20 to 40 min while keeping a vacuity of 0.1 to 1 Pa for desorbing the substances adsorbed on the surface of the workpieces to make the surface activated; in a direct current electric field of 800 to 1000 V, while keeping the same temperature as above-mentioned ionizing the gaseous sulfur into positive sulfur ions and forming sulfur plasma; directly effecting sulfurization for 1 to 30 min; and finally charging a inert or reductive gas into the vacuum chamber to cool the workpieces and then removing the workpieces from the chamber. The processing parameters of the said process are milder than those in the prior art, and by using said process energy-consumption and treatment-time can be reduced, thereby the production efficiency can be improved. In addition, the uniformity and quality of the surface treatment are improved, and rate of spoiled products due to electric shock is greatly reduced, that is especially of great advantage to the treatment for precise workpieces.

### TECHNICAL FIELD

The present invention relates to a process for plasma sulfurization of workpiece in vacuum, particularly to a process, wherein surface of workpieces made of ferrous metal, e.g. steel, is subjected to sulfurization treatment in vacuum at a lower working temperature bellow 400° C. by using plasma, in order to form a wear resist layer based on ferrous sulfide on the surface of the workpieces.

### BACKGROUND ART

Developed on the base of electrolytic sulfurization, the process for plasma sulfurization in vacuum turned the original chemical process into a physical one, thereby made the process more controllable, and the cost low. The practice for years has proved that sulfurization process is still an important surface treatment process for wear-reducing workpieces. Therefore, this process is increasingly interested.

A process of above-mentioned type is disclosed in CN 85106823A (CN 94115348), wherein the workpieces to be treated is placed on a cathode plate in a vacuum chamber, while a sulfur source is laid on a evaporating device, that is provided in the vacuum chamber and heated by using low voltage, and then the solid elementary sulfur is gasified through heating in vacuum, the resulted gaseous sulfur is ionized under the effect of a high voltage electric field between a cathode and an anode and glow discharge is carried out. Under the glow discharge, the positive sulfur ion bombed the workpieces to be treated that is arranged on cathode plate, forming a layer of sulfide. In this plasma sulfurizing process the workpieces was directly heated by plasma, i.e. in a glow heating manner.

A process for forming sulfide layer on metal surface is described in CN 1119219A, which comprises the steps: chemical cleaning workpieces being treated; applying direct or pulse negative high voltage to cause plasma glow discharge and bombing workpieces to carry out sulfurization for 20 to 60 min; and immediate dipping and cooking the workpieces treated in corrosion preventing oil.

In the light of the differences in local geometric shape of a workpiece per se, the nonuniformity of the glow discharge is unavoidable, and thus results the temperature differences in the local parts within a workpiece. In a relatively longer course of glow heating, this effect would be accumulated, thus leads to a temperature-difference up to decades of degrees centigrade, at the same time effects the surface-treatment quality negatively.

An industrial large-scale incorporated apparatus for plasma sulfurization is described in CN 2279365Y (ZL 97204602.X), wherein a secondary vacuum chamber and an electric field are provided. Said secondary vacuum chamber guarantees stable vacuity and can be further used to charge reducing gas for the protective purpose. Said electric field enables the ion stream to cut magnetic line of force. A generator for active sulfur ion is described in CN 2451602Y (ZL 00253047.3). When said apparatus and generator are used in combination, though a gradient material having nanostucture with a thickness of 100 nm to 10 μm is formed on workpiece surface under plasma state in vacuum, it is still found, that sulfurization layer is not uniform and/or homogeneous. Hence the current sulfurization processes need further improved, and it is all the more impotent especially for precise workpieces.

### DISCLOSURE OF THE INVENTION

Therefor, object of the present invention is to solve the technical problem in the prior art, namely nonuniformity and/or non-homogeneity in the sulfurization layer that can not meet the requirement particularly for sulfurizing precise workpieces by providing an improved process for plasma sulfurization in vacuum.

According to the invention, the object is accomplished by a process for plasma sulfurization in vacuum including cleaning the surface of workpieces, loading the workpieces into vacuum chamber, vacuum pumping, heating the sulfur source for sublimating thereof, making the gaseous sulfur ionized in the presence of a high electrical field and sulfurizing the workpieces, removing the workpieces from the vacuum chamber, wherein after the workpieces being cleaned, putting them into the vacuum chamber that has a pressure-rising rate up to 10⁻³ Pa/h and a ultimate vacuum up to 0.1 Pa, vacuuming to 20 to 100 Pa; heating the workpieces placed on the cathode plate at 35 to 120° C. for 20 to 40 min while keeping a vacuity of 0.1 to 1 Pa for desorbing the substances adsorbed on the surface of the workpieces to make the surface activated; in a direct current electric field of 800 to 1000 V, while keeping the same temperature as above-mentioned ionizing the gaseous sulfur into positive sulfur ions and forming sulfur plasma; directly effecting sulfurization for 1 to 30 min; and finally charging a inert or reductive gas into the vacuum chamber to cool the workpieces and then removing the workpieces from the chamber.

In order to improve the antifriction property, It is preferred, that said process comprises a further step of coating a layer of molybdenum disulfide of nanometer grade.

According to present invention, the processing conditions are milder, therewith the energy consumption can be reduced, and treatment time shortened, production efficiency enhanced. In addition, the uniformity and quality of the surface treatment are upgraded, especially the rate of spoiled products due to electric injury is significantly reduced, that is in particular favorable to the treatment of precise workpieces. For bearings of various types, the inventive process also give the effect of greatly enhance of life period, moreover the appearance quality is excellent.

### PREFFERED EMBODIMENT

### EXAMPLE 1

In this example the workpieces to be sulfurized are mating parts of spray nozzle plunger for oil pump made of 18Cᵣ2NiWA, w18Cᵣ4V steel. After the workpieces are cleaned, putt them into the vacuum chamber that has a pressure-rising rate up to 10⁻³ Pa/h and a ultimate vacuum up to 0.1 Pa, vacuum to about 20 Pa; heat the workpieces that are placed on the cathode plate at 35° C. for 20 min while keeping a vacuity of 0.1 Pa for desorbing the substances adsorbed on the surface of the workpieces to make the surface activated; in a direct current electric field of 800 V, while keeping the same temperature as above-mentioned ionizing the gaseous sulfur into positive sulfur ions and forming sulfur plasma; directly effecting sulfurization for about 1 min; and finally charging nitrogen gas into the vacuum chamber to cool the workpieces and then removing the workpieces from the chamber.

After treatment, a layer of ferrous sulfide with a thickness of about 10˜100 nm is formed on the surface of the treated workpieces. Surfaces of the workpieces thus treated have an excellent uniformity and a satisfactory appearance. Endurance test was carried out according to Chinese State Standard (GB5772-86). A record of more than 3000 hours is made with the prerequisite to guaranteeing all the property indices. This resulted data is by far greater than the requirement of 750 hours prescribed in Chinese State Standard. The test is still running at present.

What is claimed is:

1. A process for sulfurization of workpiece in vacuum, including cleaning the surface of workpieces, loading the workpieces into vacuum chamber, vacuum pumping, heating the sulfur source for sublimating thereof, making the gaseous sulfur ionized in the presence of a high electrical field and sulfurizing the workpieces, removing the workpieces from the vacuum chamber, wherein after the workpieces being cleaned, putting them into the vacuum chamber that has a pressure-rising rate up to 10⁻³ Pa/h and a ultimate vacuum up to 0.1 Pa, vacuuming to 20 to 100 Pa; heating the workpieces placed on the cathode plate at 35 to 120° C. for 20 to 40 min while keeping a vacuity of 0.1 to 1 Pa for desorbing the substances adsorbed on the surface of the workpieces to make the surface activated; in a direct current electric field of 800 to 1000 V, while keeping the same temperature as above-mentioned ionizing the gaseous sulfur into positive sulfur ions and forming sulfur plasma; directly effecting sulfurization for 1 to 30 min; and finally charging a inert or reductive gas into the vacuum chamber to cool the workpieces and then removing the workpieces from the chamber.

2. Process according to claim 1, characterized in that the process further includes a step for coating molybdenum disulfide of nanometer grade.
